(19) United States
(12) Patent Application Publication
(10) Pub. No.: US 2002/0116925 A1
(43) Pub. Date: Aug. 29, 2002

(54) Auxiliary energy management system for mobile diesel electric power plants

(76) Inventors: Gregory James Hampson, Saratoga Springs, NY (US); Robert Dean King, Schenectady, NY (US); Jochen Erich Kindling, Erie, PA (US)

Correspondence Address: GENERAL ELECTRIC COMPANY, CRD PATENT DOCKET ROOM 4A59, P O BOX 8, BUILDING K 1 SALAMONE, SCHENECTADY, NY, 12301, US

(21) Appl. No.: 09/681,225

(22) Filed: Feb. 28, 2001

(51) Int. Cl. F02B 33/44; F22D 1/00; F01B 21/04; F01K 23/00; F02B 73/00

(52) U.S. Cl. 60/605.1; 60/667; 60/698

(57) ABSTRACT

An auxiliary energy management system includes a power assist device connected to a turbocharger of a mobile power plant and operable in either electric motor or alternator modes to supply or receive rotary drive motion to or from the turbocharger, an energy storage device connected between the assist device and a main alternator of the plant and operable in either energy capture or supply modes to store electrical power or provide it to auxiliary power loads, and a control mechanism connected to the assist and storage devices and operable to convert the assist device between motor and alternator modes in response to sensing performance of the turbocharger and a diesel engine of the plant and operate the storage device in supply or capture modes.

### BACKGROUND OF INVENTION

The present invention generally relates to mobile diesel electric power plant performance in locomotives and other applications and, more particularly, is concerned with an auxiliary energy management system for use with a mobile diesel electric power plant.

Conventional mobile diesel electric power plants used in locomotives and other applications typically use turbochargers to improve high load performance. However, such power plants still suffer from the following limitations: poor transient response, limited range of high performance (usually targeted for full-load conditions), over-speed potential (especially at high altitude), over-pressure potential (especially under cold low altitude operation), and lack of assist during starting (especially under cold and high altitude conditions). In addition to performance impacts, these limitations affect the optimal design potential of diesel engines used in the mobile power plants and allow higher emissions and fuel consumption during non-optimal power settings.

Conventional approaches to improve performance of turbochargers in mobile diesel electric power plants include the provision of variable inlet guide vanes, waste gates and clutched blowers. However, these prior art approaches each address only some of the limitations mentioned above. No one of these prior art approaches addresses all of the above-mentioned limitations.

Consequently, a need exists for an innovation that will improve turbocharger performance in mobile diesel electric power plants by addressing all of the above-mentioned limitations.

### SUMMARY OF INVENTION

The present invention provides an auxiliary energy management system for use in a mobile diesel electric power plant designed to satisfy the aforementioned need. The auxiliary energy management system of the present invention combines energy management, control and storage together with energy capture within the mobile diesel electric power plant configuration to augment auxiliary power demand and enhance turbocharger performance.

In one embodiment of the present invention, an auxiliary energy management system is provided in combination with a mobile diesel electric power plant including a diesel engine, a turbocharger and a main alternator wherein the turbocharger is connected to the diesel engine so as to supply an inlet air flow thereto and to receive an exhaust air flow therefrom and the main alternator is drivingly connected to the diesel engine such that the diesel engine transmits rotary drive motion thereto causing the main alternator to generate an electrical power output. The auxiliary energy management system comprises: a power assist device connected to the turbocharger and being operable in either an electric motor mode to provide auxiliary rotary drive motion to the turbocharger or an electric alternator mode to receive rotary drive motion from the turbocharger; an energy storage device electrically connected between the power assist device and the main alternator and being operable in either an energy capture mode to store auxiliary electrical power or an energy supply mode to provide auxiliary electrical power to auxiliary power loads; and a control mechanism electrically connected to the diesel engine, turbocharger, power assist device and energy storage device and being operable to convert the power assist device to one or the other of the motor and alternator modes in response to sensing diesel engine and turbocharger performance and operate the energy storage device in a corresponding one or the other of the energy supply and capture modes.

### BRIEF DESCRIPTION OF DRAWINGS

FIG. 1 is a diagrammatic representation of a prior art mobile diesel electric power plant which includes a diesel engine, a turbocharger, a main alternator, auxiliary power loads and a control mechanism.

FIG. 2 is a diagrammatic representation of an auxiliary energy management system of the present invention associated with the prior art power plant of FIG. 1

### DETAILED DESCRIPTION

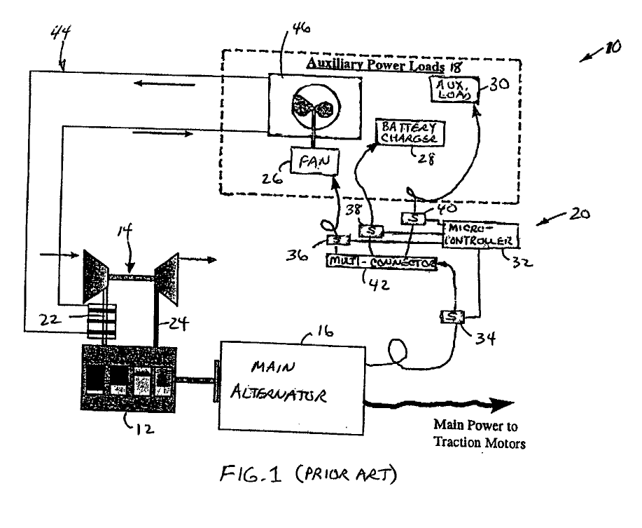

Referring now to the drawings and particularly to FIG. 1, there is shown a diagrammatic representation of a prior art mobile diesel electric power plant, generally designated 10, which includes a diesel engine 12, a turbocharger 14, a main alternator 16, a plurality of auxiliary power loads 18 and a control mechanism 20. The turbocharger 14 is connected to the diesel engine 12 so as to supply an inlet air flow 22 thereto and to receive an exhaust air flow 24 therefrom. The main alternator 16 is drivingly connected to the diesel engine 12 such that the diesel engine 12 transmits rotary drive motion to the main alternator 16 which, in turn, generates and supplies electrical power to any desired devices, such as traction motors (not shown) employed by a locomotive. The auxiliary power loads 18 can take various suitable forms, for example, a radiator fan 26, battery charger 28 and auxiliary load 30. The control mechanism 20 can take various suitable forms, for example, it can include a suitable conventional microcontroller 32 and a plurality of switches 34, 36, 38, 40 which are electrically connected to the microcontroller 32. A first switch 34 of the plurality thereof is electrically connected between the main alternator 16 and a multi-plug electrical connector device 42 and second switches 36, 38, 40 of the plurality thereof are electrically connected between the connector device 42 and the auxiliary power loads 18, specifically, the radiator fan 26, battery charger 28 and auxiliary load 30, so as to electrically enable control of the supply of electrical power from the main alternator 16 to the fan 26, battery charger 28 and auxiliary load 30 of the auxiliary power loads 18. Also, a closed loop 44 is provided in a heat exchange relationship between the inlet air flow 22 and a radiator 46 associated with the radiator fan 26 which provides for preheating of the inlet air flow 22 to the diesel engine 12.

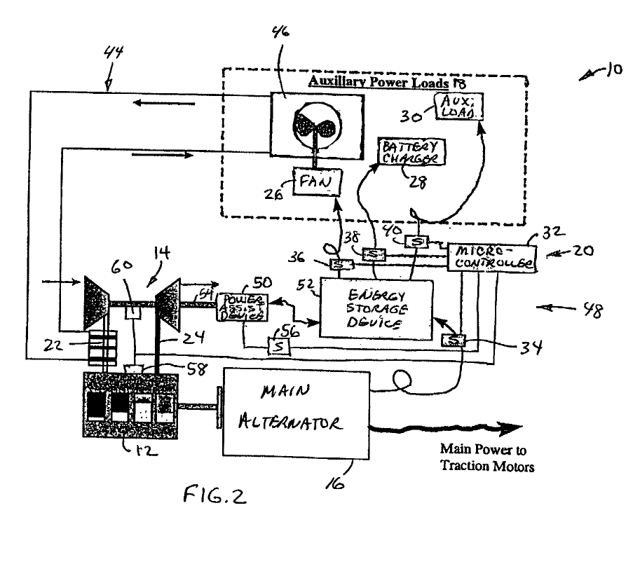

Referring now to FIG. 2, there is shown a diagrammatic representation of an auxiliary energy management system of the present invention, generally designated 48, associated with the above-described prior art mobile diesel electric power plant 10 of FIG. 1. The auxiliary energy management system 48 includes a power assist device 50 and an energy storage device 52. The power assist device 50 is connected via a common shaft 54 with the turbocharger 14 so as to be operable in an auxiliary electric motor mode to provide rotary drive motion to the turbocharger 14 or in an auxiliary alternator mode to receive rotary drive motion from the turbocharger 14. The control mechanism 20 also includes a third switch 56 connected between the microcontroller 32 and the power assist device 50 so as to electrically enable converting of the power assist device 50 between the motor and alternator modes thereof. The energy storage device 52 is electrically connected between the auxiliary power loads 18 and the main alternator 16 and is operable in either an energy capture mode to store auxiliary electrical power or an energy supply mode to provide auxiliary electrical power to auxiliary power loads 18. More specifically, the energy storage device 52 is electrically connected on an input side thereof via the first switch 34 of the control mechanism 20 to the main alternator 16 so as to electrically enable control of supply of electrical power from the main alternator 16 to the energy storage device 52, and the energy storage device 52 is electrically connected on an output side thereof via the second switches 36, 38, 40 of the control mechanism 20 respectively to the fan 26, battery charger 28 and auxiliary load 30 of the auxiliary power loads 18 so as to electrically enable control of supply of electrical power from the energy storage device 52 to selected ones of the fan 26, battery charger 28 and auxiliary load 30. The control mechanism 20 is also electrically connected to the diesel engine 12 and turbocharger 14 by means of suitable sensors 58, 60 which are adapted to sense the performance of the diesel engine 12 and turbocharger 14. The microcontroller 32 in response to the sensing of the performance of the diesel engine 12 and turbocharger 14, via the sensors 58, 60, controls actuation of the second switches 36, 38, 40 which, in turn, enables control of the supply of electrical power from the energy storage device 52 to selected ones of the auxiliary power loads 18.

The auxiliary energy management system 48 being located on-board the mobile power plant 10 provides a means to reduce transient demand on the power plant 10, reduce auxiliary loads during peak power demand, better manage application of auxiliary loads (e.g. loads take turns, loads are withheld during engine transients) and capture extra energy that is normally lost (exhaust/turbo, dynamic brake, heat removal) which can be used at a different time in the duty-cycle or performance envelope. Thus, the system 48 is used to manage auxiliary power demands, turbocharger performance and energy capture. On one extreme, a large/long-term energy storage capacity allows the auxiliary loads to be completely independent of the diesel engine 12 and to be powered by “wasted energy” only, which relieves the diesel engine 12 from the job of providing power to auxiliaries with a net improvement in total system efficiency by the reduction of auxiliary energy (this scale would include dynamic braking power levels). On the other extreme, a small/short-term energy storage capacity provides a means to trim auxiliary power demand from the diesel engine 12 and manage auxiliary power transients (including the electrical assist turbocharger).

Moreover, the power assist device 50 of the system 48 of the present invention when acting in its electric motor mode draws electrical power from the energy storage device 52 to increase turbocharger shaft rotational power and thus augment the energy available in the diesel engine exhaust to provide the optimal air flow to the diesel engine 12 for all conditions. Or, the power assist device 50 when acting in reverse or in its electric alternator mode extracts or captures extra energy from the exhaust stream above that which is needed to power a compressor of the turbocharger 14 and supply air to the diesel engine 12. In the alternator mode, the power assist device 50 can limit high altitude and unexpected turbocharger shaft over speed by drawing power out of the turbocharger 14 to slow it down. Furthermore, the power assist device 50, in an appropriate one of its modes, can provide precise control of the diesel engine manifold pressure and substantially reduce the transient response time of the turbocharger 14.

In conclusion, the auxiliary energy management system 48 of the present invention enables a more precise control of turbocharger shaft speed and air flow, in addition to enabling energy capture. The benefits include improved reliability of the diesel engine 12 and turbocharger 14, improved transient response, reduced emissions from transients and low air flow, and better matching of the turbocharger 14 and diesel engine 12 over the duty cycle resulting in improved efficiency and emissions at all times.

It is thought that the present invention and its advantages will be understood from the foregoing description and it will be apparent that various changes may be made thereto without departing from the spirit and scope of the invention or sacrificing all of its material advantages, the form hereinbefore described being merely preferred or exemplary embodiment thereof.

1. An auxiliary energy management system in combination with a mobile diesel electric power plant including a diesel engine, a turbocharger and a main alternator, wherein said turbocharger is connected to said diesel engine so as to supply an inlet air flow thereto and to receive an exhaust air flow therefrom and said main alternator is drivingly connected to said diesel engine such that said diesel engine transmits rotary drive motion thereto causing said main alternator to generate an electrical power output, said auxiliary energy management system comprising:
a power assist device connected to said turbocharger and being operable in either an electric motor mode to provide auxiliary rotary drive motion to said turbocharger or an electric alternator mode to receive rotary drive motion from said turbocharger;
an energy storage device electrically connected between said power assist device and said main alternator and being operable in either an energy capture mode to store auxiliary electrical power or an energy supply mode to provide auxiliary electrical power to auxiliary power loads; and a control mechanism electrically connected to said diesel engine, said turbocharger, said power assist device and said energy storage device and being operable to convert said power assist device to one or the other of said motor and alternator modes in response to sensing performance of said diesel engine and said turbocharger and operate said energy storage device in a corresponding one or the other of said energy supply and capture modes.

2. The combination of claim 1 wherein said control mechanism includes a microcontroller and a switch electrically connected between said microcontroller and said power assist device so as to electrically enable converting of said power assist device between said motor and alternator modes thereof.

3. The combination of claim 1 wherein at least one auxiliary power load is provided and said control mechanism includes a microcontroller and at least one switch electrically connected to said microcontroller and between an output side of said energy storage device and said auxiliary power load so as to electrically enable control of supply of electrical power from said energy storage device to said auxiliary power load.

4. The combination of claim 3 wherein said control mechanism further includes another switch connected between said main alternator and an input side of said energy storage device so as to electrically enable control of supply of electrical power from said main alternator to said energy storage device.

5. The combination of claim 3 wherein said control mechanism further includes another switch connected between said microcontroller and said power assist device so as to electrically enable converting of said power assist device between said motor and alternator modes thereof.

6. An auxiliary energy management system in combination with a mobile diesel electric power plant including a diesel engine, a turbocharger, a main alternator and a plurality of auxiliary power loads, wherein said turbocharger is connected to said diesel engine so as to supply an inlet air flow thereto and to receive an exhaust air flow therefrom and said main alternator is drivingly connected to said diesel engine such that said diesel engine transmits rotary drive motion thereto causing said main alternator to generate an electrical power output, said auxiliary energy management system comprising:
a power assist device connected to said turbocharger and being operable in either an electric motor mode to provide auxiliary rotary drive motion to said turbocharger or an electric alternator mode to receive rotary drive motion from said turbocharger;
an energy storage device electrically connected between said power assist device and said main alternator and being operable in either an energy capture mode to store auxiliary electrical power or an energy supply mode to provide auxiliary electrical power to said auxiliary power loads; and
a control mechanism electrically connected to said diesel engine, said turbocharger, said power assist device and said energy storage device and being operable to convert said power assist device to one or the other of said motor and alternator modes in response to sensing performance of said diesel engine and said turbocharger and operate said energy storage device in a corresponding one or the other of said energy supply and capture modes, said control mechanism also being electrically connected between said energy storage device and said plurality of auxiliary power loads so as to enable control of supply of electrical power from said energy storage device to said auxiliary power loads.

7. The combination of claim 6 wherein said control mechanism includes a microcontroller and a switch electrically connected between said microcontroller and said power assist device so as to electrically enable converting of said power assist device between said motor and alternator modes thereof.

8. The combination of claim 6 wherein said control mechanism includes a microcontroller and a plurality of switches electrically connected to said microcontroller and between an output side of said energy storage device and said auxiliary power loads so as to electrically enable control of supply of electrical power from said energy storage device to selected ones of said auxiliary power loads.

9. The combination of claim 8 wherein said control mechanism further includes another switch connected between said main alternator and an input side of said energy storage device so as to electrically enable control of supply of electrical power from said main alternator to said energy storage device.

10. The combination of claim 8 wherein said control mechanism further includes another switch connected between said microcontroller and said power assist device so as to electrically enable converting of said power assist device between said motor and alternator modes thereof.
